(19) United States
(12) Patent Application Publication
(10) Pub. No.: US 2024/0176888 A1
(43) Pub. Date: May 30, 2024

(54) METHOD OF DETECTING VULNERABILITIES OF CONTAINER IMAGES AT RUNTIME

(71) Applicant: VMware, Inc., Palo Alto, CA (US)

(72) Inventors: Shani SAHAR-KANETI, Rehovot (IL); Yonatan SHURANY, Oranit (IL); Haim HELMAN, San Jose, CA (US); Edo Yacov DEKEL, Tel-Aviv (IL)

(21) Appl. No.: 17/994,202

(22) Filed: Nov. 25, 2022

(51) Int. Cl. G06F 21/57

(52) U.S. Cl. CPC G06F 21/577; G06F 2221/034

(57) ABSTRACT

A method of detecting at runtime, vulnerabilities of container images used by a plurality of containers, includes the steps of: transmitting a request, to an interface to one or more container runtimes, for a list of container images; in response to receiving the list of container images from the interface, generating a list of software packages of a container image that is listed; and transmitting, via a gateway, the list of software packages to a vulnerability detection service for the vulnerability detection service to detect a vulnerability of at least one of the software packages.

### BACKGROUND

Applications are often deployed using containers. Containers are standalone units of software, each including one or more processes executing therein. Each container runs using a container image, which is a static file that includes all the software packages used by the container's processes. A known problem with deploying applications using containers is detecting vulnerabilities of the images, specifically with the packages thereof. One approach is to scan all the images of a computer system at the time the images are built. However, this approach may be inefficient. For example, several of the images may not ultimately be used, making it unnecessary to scan them. Furthermore, if a computer that is performing the scans accesses the images from a repository, credentials for accessing the repository must be provided securely to the computer.

Furthermore, the above approach may be ineffective. For example, if a container is already running, and its image was not scanned during the build process, then that container will continue executing without its image being scanned. Additionally, new vulnerabilities are discovered regularly. At the time that an image is scanned, it may be that none of its packages have any known vulnerabilities. If a new vulnerability is then discovered, but the image is not scanned again, one or more containers will continue executing with the vulnerable image. A more efficient and effective method of detecting vulnerabilities of images is needed.

### SUMMARY

Accordingly, one or more embodiments provide a method of detecting at runtime, vulnerabilities of container images used by a plurality of containers. The method includes the steps of: transmitting a request, to an interface to one or more container runtimes, for a list of container images; in response to receiving the list of container images from the interface, generating a list of software packages of a container image that is listed; and transmitting, via a gateway, the list of software packages to a vulnerability detection service for the vulnerability detection service to detect a vulnerability of at least one of the software packages.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a hybrid cloud computer system in which embodiments may be implemented.

FIG. 2 is a flow diagram of a method performed by scanner software, a container runtime interface (CRI), and a vulnerability detection service to scan images used by containers at runtime, according to an embodiment.

FIG. 3 is a flow diagram of a method performed by the vulnerability detection service to compare a software bill of material (SBOM) to a known vulnerabilities list to detect vulnerabilities, according to an embodiment.

FIG. 4 is a flow diagram of a method performed by a node of the computer system to update a vulnerable image, according to an embodiment.

### DETAILED DESCRIPTION

Techniques for detecting vulnerabilities of images are described. According to embodiments, containers run on a server (referred to herein as a “node”) in an on-premise data center of an organization. Images are scanned for vulnerabilities at runtime, so compute resources are not wasted scanning images that are built but not later used. Furthermore, the images are scanned for names and version numbers of packages therein, by a scanner that executes on the node. Accordingly, the scanner has direct access to the images to be scanned (without requiring credentials for accessing a repository to access the images). The scanner transmits a list of packages to a vulnerability detection service of a cloud data center, and the vulnerability detection service determines whether any of the packages have any known vulnerabilities.

Because the images are scanned at runtime, the above issue with an image not having been scanned during the build process, is avoided. Furthermore, according to embodiments, a schedule may be applied to each of the images being used by running containers or to a selected group of the images. According to the schedule, the scanner periodically scans images for packages to be checked for vulnerabilities. As such, if a new vulnerability is discovered for a package, an image that includes that package is eventually scanned, and the vulnerability is detected. These and further aspects of the invention are discussed below with respect to the drawings.

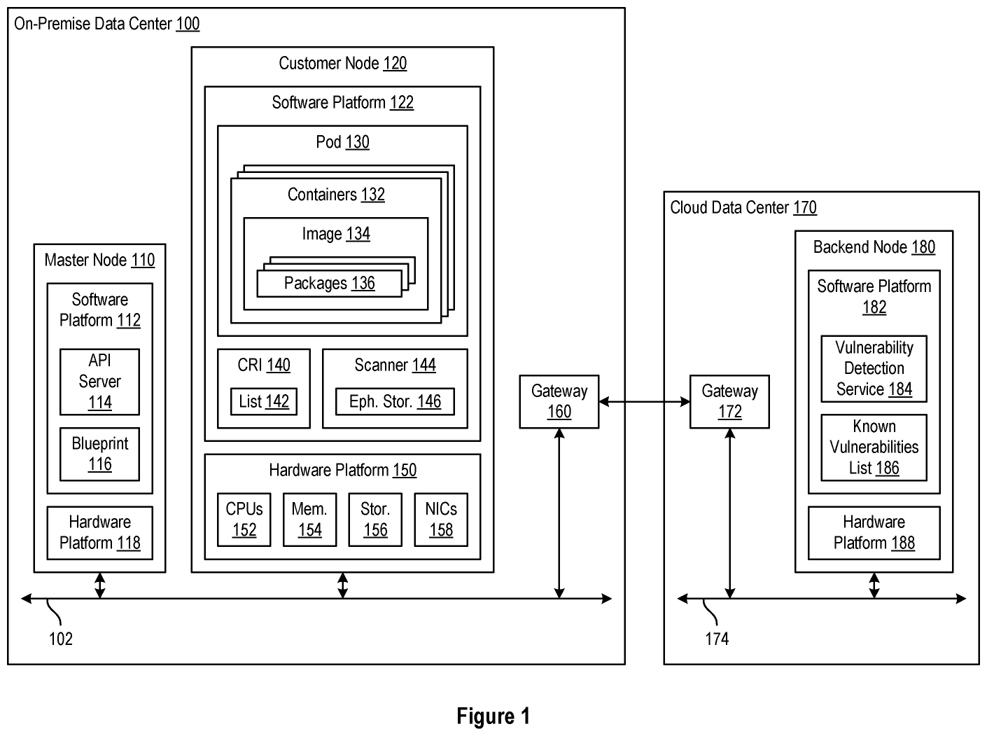

FIG. 1 is a block diagram of a hybrid cloud computer system in which embodiments may be implemented. The computer system includes an on-premise data center 100 and a cloud data center 170. On-premise data center 100 is controlled and administrated by a particular organization. Cloud data center 170 may be operated by a cloud computing service provider to expose “public” cloud services to various account holders. Cloud data center 170 may also be operated by the organization that controls on-premise data center 100 as a “private” cloud service.

On-premise data center 100 includes a master node 110, a customer node 120, and a gateway 160. In embodiments discussed herein, an application of on-premise data center 100 is deployed on a Kubernetes® platform. However, in alternative embodiments, the application is deployed in other computing environments. Master node 110 is a server that includes a server-grade hardware platform 118 such as an x86 architecture platform. Hardware platform 118 includes conventional components of a computing device (not shown), such as one or more central processing units (CPUs), memory, local storage, and one or more network interface cards (NICs). Hardware platform 118 supports a software platform 112, which includes an application programming interface (API) server 114 and a blueprint 116.

API server 114 is a control plane for the application deployed in on-premise data center 100. Based on inputs from a command-line interface (CLI) and a reference configuration file (not shown), API server 114 generates blueprint 116. Blueprint 116 defines the desired state of the application. The application is deployed on customer node 120. Customer node 120 is a server constructed on a server-grade hardware platform 150 such as an x86 architecture platform. For simplicity, only one customer node 120 is illustrated in on-premise data center 100. However, in actual implementations, there may be any number of customer nodes in on-premise data center 100, and the application may be distributed across the customer nodes.

Like hardware platform 118, hardware platform 150 includes conventional components of a computing device, such as one or more CPUs 152, memory 154 such as random-access memory (RAM), local storage 156 such as one or more magnetic drives or solid-state drives (SSDs), and one or more NICs 158. CPUs 152 are configured to execute instructions such as executable instructions that perform one or more operations described herein, which may be stored in memory 154. NICs 158 enable customer node 120 to communicate with master node 110, with gateway 160, and with other devices (not shown) over a physical network 102, which is a local area network (LAN) of on-premise data center 100.

Hardware platform 150 supports a software platform 122. Software platform 122 includes a pod 130, a CRI 140, and scanner software 144. The application of on-premise data center 100 runs on containers 132 of pod 130, such as Docker® containers. Each of containers 132 executes using an image 134, which is a static file that includes a plurality of packages 136 used by processes of container 132. For simplicity, only one pod 130 is illustrated in software platform 122. However, in actual implementations, there may be any number of pods executing in customer node 120. All the images currently being used by running containers 132 of software platform 122, are referred to herein as “images 134.”

CRI 140 is an interface to one or more container runtimes used by pod 130, such as Containerd.® CRI 140 maintains a running images list 142, which includes (1) names and identifiers of containers 132, and (2) for each of containers 132, an identifier of image 134 used thereby. Scanner 144 is a container such as a Docker® container, that scans images 134 to generate SBOMs. An SBOM lists the name and version number of each of packages 136 of one of images 134. Scanner 144 includes ephemeral storage 146, which is a portion of storage 156 storing data that is erased if scanner 144 crashes or is uninstalled. To scan images 134, scanner 144 copies images 134 to ephemeral storage 146 and scans the copy for names and version numbers of packages 136 therein.

After generating the SBOMs, scanner 144 transmits the SBOMs via gateway 160 to a vulnerability detection service 184 of cloud data center 170. Gateway 160 is a physical networking device or a computer program executing in a server of on-premise data center 100. Gateway 160 provides master node 110, customer node 120, and other devices in on-premise data center 100, connectivity to an external network, e.g., the Internet. Gateway 160 manages public internet protocol (IP) addresses for master node 110 and customer node 120, and routes traffic incoming to and outgoing from on-premise data center 100.

Cloud data center 170 includes a backend node 180 and a gateway 172. Backend node 180 is a server that includes a server-grade hardware platform 188 such as an x86 architecture platform. Like hardware platforms 118 and 150, hardware platform 188 includes conventional components of a computing device (not shown), such as one or more CPUs, memory, local storage, and one or more NICs. Hardware platform 188 supports a software platform 182, which includes vulnerability detection service 184 and a known vulnerabilities list 186.

Vulnerability detection service 184 is a container such as a Docker® container that matches packages from SBOMs to packages from known vulnerabilities list 186. In embodiments in which cloud data center 170 provides public cloud services, vulnerability detection service 184 performs such matching for multiple account holders to detect known vulnerabilities. Known vulnerabilities list 186 lists packages for which vulnerabilities have been discovered. For example, known vulnerabilities list 186 may be a list published by a vendor of an operating system (OS) or may be a list downloaded from a publicly available online database. Each entry of known vulnerabilities list 186 includes (1) a name of a package, and (2) a range of version numbers that are vulnerable, e.g., open secure sockets layer (OpenSSL®) version 1.0.1 to version 1.0.7.

Vulnerability detection service 184 receives SBOMs from scanner 144 via gateway 172 and a physical network 174, which is a LAN of cloud data center 170. Gateway 172 is a physical networking device or a computer program executing in a server of cloud data center 170. Gateway 172 provides backend node 180 and other devices (not shown) in cloud data center 170, connectivity to the external network. Gateway 172 manages public IP addresses for backend node 180, and routes traffic incoming to and outgoing from cloud data center 170.

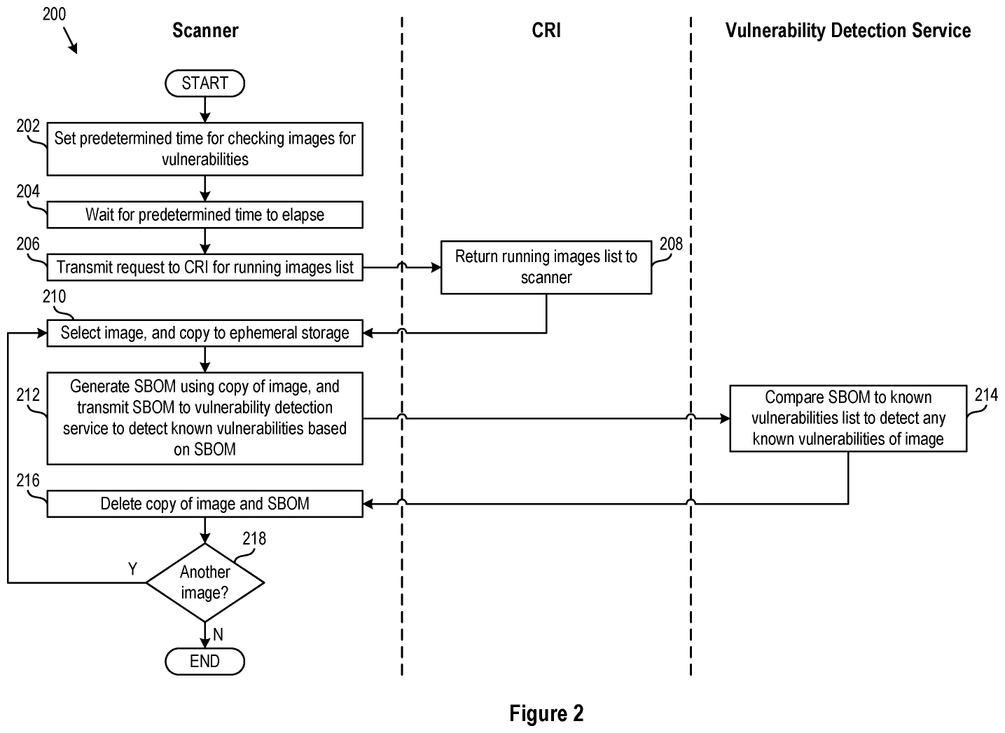

FIG. 2 is a flow diagram of a method 200 performed by scanner 144, CRI 140, and vulnerability detection service 184 to scan images 134 at runtime, according to an embodiment. At step 202, scanner 144 sets a predetermined time for checking images 134 for vulnerabilities. For example, an administrator of on-premise data center 100 may request via API server 114, for scanner 144 to set the predetermined time to twenty-four hours, in which case scanner 144 scans images 134 daily. At step 204, scanner 144 waits for the predetermined time to elapse.

At step 206, in response to the predetermined time elapsing, scanner 144 transmits a request to CRI 140 for running images list 142. At step 208, CRI 140 transmits a copy of running images list 142 to scanner 144, which scanner 144 stores in memory 154. At step 210, scanner 144 selects one of images 134 that is listed in running images list 142. Scanner 144 also locates a corresponding one of containers 132 based on the name and identifier of container 132 from running images list 142. Scanner 144 then copies the selected one of images 134 from the corresponding one of containers 132 to ephemeral storage 146.

At step 212, scanner 144 generates an SBOM from the copy of image 134, the SBOM including a name and version number of each of packages 136 of image 134. Scanner 144 stores the SBOM in memory 154. For example, to determine the names and version numbers of each of packages 136, scanner 144 may locate copies of packages 136 within the copy of image 134. Scanner 144 may locate packages 136 by searching for types of files that often contain packages, such as JAR files in the case of Java® packages. Alternatively, if available, to determine the names and version numbers of packages 136, scanner 144 may locate an OS package manifest within the copy of image 134, which includes the names and version numbers. Scanner 144 transmits the SBOM to vulnerability detection service 184 via gateway 160, for vulnerability detection service 184 to detect any known vulnerabilities based on the SBOM.

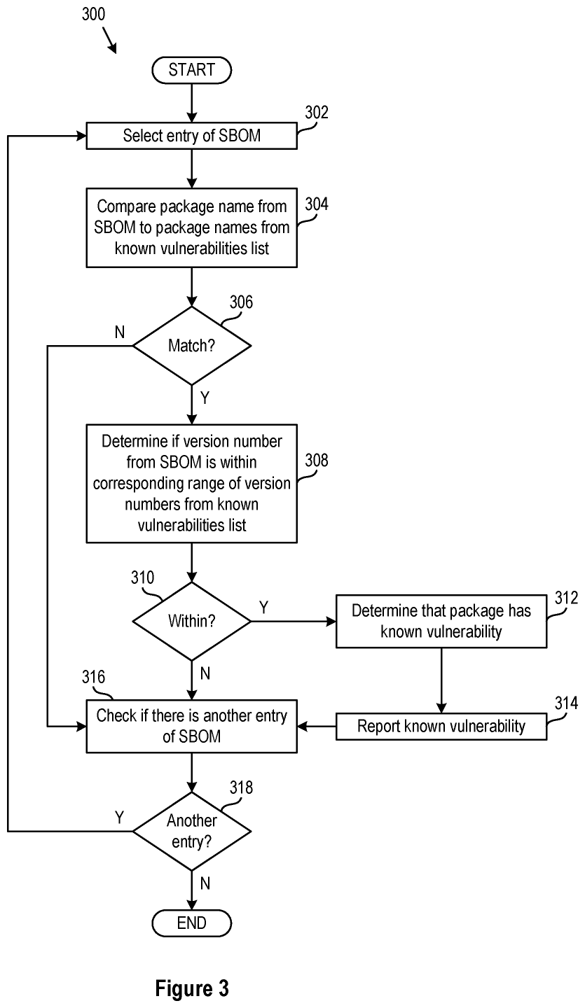

At step 214, vulnerability detection service 184 compares the SBOM to known vulnerabilities list 186 to determine if there are any matches, i.e., to detect any known vulnerabilities of packages listed by the SBOM, as discussed further below in conjunction with FIG. 3. At step 216, scanner 146 deletes the copy of image 134 from ephemeral storage 146 and the SBOM from memory 154. At step 218, if there is another one of images 134 listed in running images list 142, method 200 returns to step 210, and scanner 144 selects the next one of images 134 to copy to ephemeral storage 146.

Otherwise, if there is not another one of images 134 listed, method 200 ends, and scanner 144 deletes its copy of running images list 142 from memory 154. It should be noted that the administrator of on-premise data center 100 may specify to only scan some of images 134 periodically. Furthermore, the administrator may specify different predetermined times for scanning different ones of images 134. Accordingly, steps 210-216 may be performed for images 134 on varying schedules.

FIG. 3 is a flow diagram of a method 300 performed by vulnerability detection service 184 to compare an SBOM to known vulnerabilities list 186, according to an embodiment. At step 302, vulnerability detection service 184 selects an entry of the SBOM, the entry including a name and version number of one of packages 136. At step 304, vulnerability detection service 184 compares the package name from the entry of the SBOM to each of the package names from known vulnerabilities list 186. At step 306, if there is a match, method 300 moves to step 308.

At step 308, vulnerability detection service 184 determines if the version number of the selected entry of the SBOM is within a range of version numbers specified by known vulnerabilities list 186. Specifically, vulnerability detection service 184 checks a range of version numbers corresponding to the package name of the selected entry of the SBOM. At step 310, if the version number from the SBOM is within the range of version numbers from known vulnerabilities list 186, method 300 moves to step 312. For example, the entry of the SBOM may be “OpenSSL version 1.0.1,” and there may be a known vulnerability for versions 1.0.1 to 1.0.7 of the OpenSSL package.

At step 312, vulnerability detection service 184 determines that package 136 identified by the selected entry of the SBOM has the known vulnerability. At step 314, vulnerability detection service 184 reports the known vulnerability to the administrator of on-premise data center 100, e.g., via an alert message indicating the name and version number of package 136 and information about the known vulnerability. Vulnerability detection service 184 posts the alert message in a control panel of cloud data center 170 to be viewed by the administrator, e.g., by navigating to a web page associated with the control panel. Returning to step 306, if there is no match between package names, vulnerability detection service 184 determines that package 136 identified by the selected entry of the SBOM is not vulnerable, and method 300 moves directly to step 316.

Similarly, returning to step 310, if the version number of package 136 is not within the corresponding range of version numbers from known vulnerabilities list 186, vulnerability detection service 184 determines that package 136 is not vulnerable, and method 300 moves directly to step 316. At step 316, vulnerability detection service 184 checks if there is another entry of the SBOM to compare to known vulnerabilities list 186. At step 318, if there is another entry, method 300 returns to step 302, and vulnerability detection service 184 selects the next entry. Otherwise, if there are no more entries of the SBOM to compare, method 300 ends.

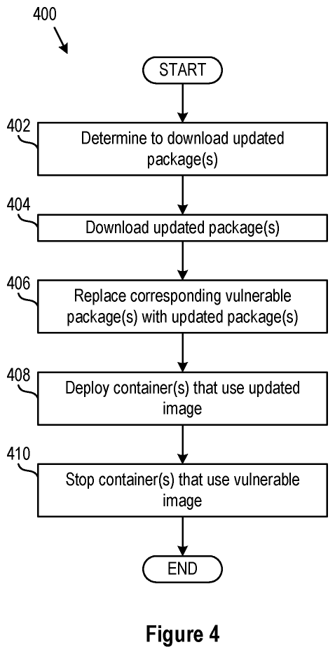

FIG. 4 is a flow diagram of a method 400 performed by customer node 120 to update a vulnerable one of images 134, according to an embodiment. At step 402, customer node 120 determines to download an updated package(s). For example, in response to vulnerability detection service 184 detecting one or more vulnerable packages, the administrator may instruct customer node 120 via API server 114, to download a newer version(s) of the one or more vulnerable packages. At step 404, customer node 120 downloads the updated package(s). At step 406, customer node 120 replaces the one or more vulnerable packages of image 134 with the updated package(s).

At step 408, customer node 120 deploys one or more containers 132 that use image 134 with the updated package(s). At step 410, customer node 120 stops any of containers 132 that use image 134 with the vulnerable package(s). After step 410, method 400 ends. It should be noted that instead of downloading an updated package(s), customer node 120 may remediate vulnerabilities in other ways. For example, customer node 120 may simply delete any vulnerable packages from image 134 and deploy one or more containers 132 that use image 134 without the vulnerable packages.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host server, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of detecting at runtime, vulnerabilities of container images used by a plurality of containers, the method comprising:
transmitting a request, to an interface to one or more container runtimes, for a list of container images;
in response to receiving the list of container images from the interface, generating a list of software packages of a container image that is listed; and
transmitting, via a gateway, the list of software packages to a vulnerability detection service for the vulnerability detection service to detect a vulnerability of at least one of the software packages.

2. The method of claim 1, wherein the vulnerability detection service is a container, and the vulnerability detection service determines as a result of the detected vulnerability of the at least one of the software packages, that the container image is vulnerable.

3. The method of claim 2, wherein based on the vulnerability detection service determining that the container image is vulnerable, a server downloads at least one updated software package, replaces the at least one of the software packages with the at least one updated software package, and deploys a container that uses the container image including the at least one updated software package.

4. The method of claim 1, wherein the vulnerability detection service detects the vulnerability of the at least one of the software packages, by matching a package name from the list of software packages to a package name from a list of known vulnerabilities, and determining that a version number from the list of software packages is within a range of version numbers from the list of known vulnerabilities.

5. The method of claim 1, wherein the steps of transmitting the request for the list of container images, generating the list of software packages, and transmitting the list of software packages to the vulnerability detection service, are performed by scanner software executed on a server on which the containers are executing.

6. The method of claim 1, further comprising:
copying the container image to ephemeral storage, wherein said generating of the list of software packages, is performed using the copy of the container image in the ephemeral storage.

7. The method of claim 1, further comprising:
setting a predetermined time for checking for vulnerabilities, wherein said generating of the list of software packages, is performed in response to the predetermined time elapsing.

8. A non-transitory computer-readable medium comprising instructions that are executable in a computer system, wherein the instructions when executed cause the computer system to carry out a method of detecting at runtime, vulnerabilities of container images used by a plurality of containers, the method comprising:
transmitting a request, to an interface to one or more container runtimes, for a list of container images;
in response to receiving the list of container images from the interface, generating a list of software packages of a container image that is listed; and
transmitting, via a gateway, the list of software packages to a vulnerability detection service for the vulnerability detection service to detect a vulnerability of at least one of the software packages.

9. The non-transitory computer-readable medium of claim 8, wherein the vulnerability detection service is a container, and the vulnerability detection service determines as a result of the detected vulnerability of the at least one of the software packages, that the container image is vulnerable.

10. The non-transitory computer-readable medium of claim 9, wherein based on the vulnerability detection service determining that the container image is vulnerable, a server downloads at least one updated software package, replaces the at least one of the software packages with the at least one updated software package, and deploys a container that uses the container image including the at least one updated software package.

11. The non-transitory computer-readable medium of claim 8, wherein the vulnerability detection service detects the vulnerability of the at least one of the software packages, by matching a package name from the list of software packages to a package name from a list of known vulnerabilities, and determining that a version number from the list of software packages is within a range of version numbers from the list of known vulnerabilities.

12. The non-transitory computer-readable medium of claim 8, wherein the steps of transmitting the request for the list of container images, generating the list of software packages, and transmitting the list of software packages to the vulnerability detection service, are performed by scanner software executed on a server on which the containers are executing.

13. The non-transitory computer-readable medium of claim 8, the method further comprising:
copying the container image to ephemeral storage, wherein said generating of the list of software packages, is performed using the copy of the container image in the ephemeral storage.

14. The non-transitory computer-readable medium of claim 8, the method further comprising:
setting a predetermined time for checking for vulnerabilities, wherein said generating of the list of software packages, is performed in response to the predetermined time elapsing.

15. A computer system comprising a server on which a plurality of containers are executing using container images, wherein scanner software executing on the server is configured to:
transmit a request, to an interface to one or more container runtimes, for a list of container images;
in response to receiving the list of container images from the interface, generate a list of software packages of a container image that is listed; and
transmit, via a gateway, the list of software packages to a vulnerability detection service for the vulnerability detection service to detect a vulnerability of at least one of the software packages.

16. The computer system of claim 15, wherein the vulnerability detection service is a container, and the vulnerability detection service determines as a result of the detected vulnerability of the at least one of the software packages, that the container image is vulnerable.

17. The computer system of claim 16, wherein based on the vulnerability detection service determining that the container image is vulnerable, the server downloads at least one updated software package, replaces the at least one of the software packages with the at least one updated software package, and deploys a container that uses the container image including the at least one updated software package.

18. The computer system of claim 15, wherein the vulnerability detection service detects the vulnerability of the at least one of the software packages, by matching a package name from the list of software packages to a package name from a list of known vulnerabilities, and determining that a version number from the list of software packages is within a range of version numbers from the list of known vulnerabilities.

19. The computer system of claim 15, wherein the scanner software is further configured to:
copy the container image to ephemeral storage, wherein said generating of the list of software packages, is performed using the copy of the container image in the ephemeral storage.

20. The computer system of claim 15, wherein the scanner software is further configured to:
set a predetermined time for checking for vulnerabilities, wherein said generating of the list of software packages, is performed in response to the predetermined time elapsing.
